(19) United States
(12) Patent Application Publication
(10) Pub. No.: US 2018/0063882 A1
(43) Pub. Date: Mar. 1, 2018

(54) METHOD OF TELEMATICS CONNECTIVITY MANAGEMENT

(71) Applicant: GM GLOBAL TECHNOLOGY OPERATIONS LLC, Detroit, MI (US)

(72) Inventors: Andrew J. MacDonald, Grosse Pointe Park, MI (US); George Knish, Rochester Hills, MI (US); James J. Piwowarski, Holly, MI (US); Scott T. Droste, West Bloomfield, MI (US)

(21) Appl. No.: 15/248,448

(22) Filed: Aug. 26, 2016

(51) Int. Cl. H04W 76/04; H04W 4/00; H04W 76/02

(52) U.S. Cl. CPC H04W 76/04; H04W 4/005; H04W 76/027; H04W 76/028; H04W 76/023

(57) ABSTRACT

A method of connectivity management of a telematics unit. The method includes: setting, via a controller, a telematics unit at a first connectivity mode; establishing, via an antenna, communications with a wireless carrier system at the first connectivity mode; determining, via the controller, that the vehicle has encountered a connectivity-type event; shifting, via the controller, the telematics unit from the first connectivity mode to a second connectivity mode; and establishing, via the antenna, communications with the wireless carrier system at the second connectivity mode.

### INTRODUCTION

Cellular networks are not ubiquitous. A certain percentage of voice and data calls fail to connect with their intended wireless carrier system. When considering vehicle telematics, failed calls can be detrimental for certain critical applications such as vehicle-crash notification and emergency calls. However, due to its low data throughput and relaxed latency requirements, an Internet-of-Things (IoT) connectivity, typically implemented through a 4.5G or 5G 3GPP standard (Third Generation Partnership Project standard), can be far more pervasive than other 3GPP connectivity types. The Internet-of-Things (IoT) connectivity may therefore be implemented to provide a stronger chance of caller success when other 3GPP connections cannot be established.

The telematics unit moreover draws energy from the battery when the vehicle is not charging (ignition-off). While the telematics unit is allocated an energy budget, in order to meet its budget, the telematics unit is only allowed stay active for predetermined time period. As follows, during this time period, the unit can be reached to perform fundamental functions such as remote start or door unlock. After this period concludes, however, the telematics unit is rendered inoperable and cannot be reached to perform such functions. Due to its low data throughput and relaxed latency requirements, the Internet-of-Things connectivity draws little energy and would thus allow the telematics unit to remain active for longer periods of time without exceeding the allocated energy budget. It is therefore desirable for the telematics unit to incorporate a management configuration which enables it to take advantage of the Internet-of-Things connectivity types for improved performance under certain circumstances.

### SUMMARY

A method of connectivity management of a telematics unit is herein presented. The method includes: setting, via a controller, a telematics unit in a first connectivity mode; establishing, via an antenna, communications with a wireless carrier system in the first connectivity mode; determining, via the controller, that the vehicle has encountered a connectivity-type event; shifting, via the controller, the telematics unit from the first connectivity mode to a second connectivity mode; and establishing, via the antenna, communications with the wireless carrier system in the second connectivity mode.

The method may further include attempting to reestablish the wireless carrier system communications at in the first connectivity mode. The connectivity-type event may be the vehicle being turned OFF. The connectivity-type event may also be the vehicle operating on a battery at a predetermined state-of-charge. The connectivity-type event may also be created by the controller and based on a specific time. The specific time may be based upon the expiration of a predetermined timer value.

The connectivity-type event may be a failed attempt to send a vehicle-crash notification and/or establish an emergency call. The low-connectivity event may occurs when normal connectivity type fails to reach wireless carrier system or the vehicle is at a location with no service connectivity.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2 is a view of an exemplary vehicle in an exemplary environment in which an embodiment of a method of Vehicle Telematics Connectivity Management may be implemented;

FIG. 3 is an exemplary flow chart of an exemplary algorithmic method of Vehicle Telematics Connectivity Management; and

FIG. 4 is an exemplary flow chart of another exemplary algorithmic method of Vehicle Telematics Connectivity Management.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the exemplary aspects of the present disclosure. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

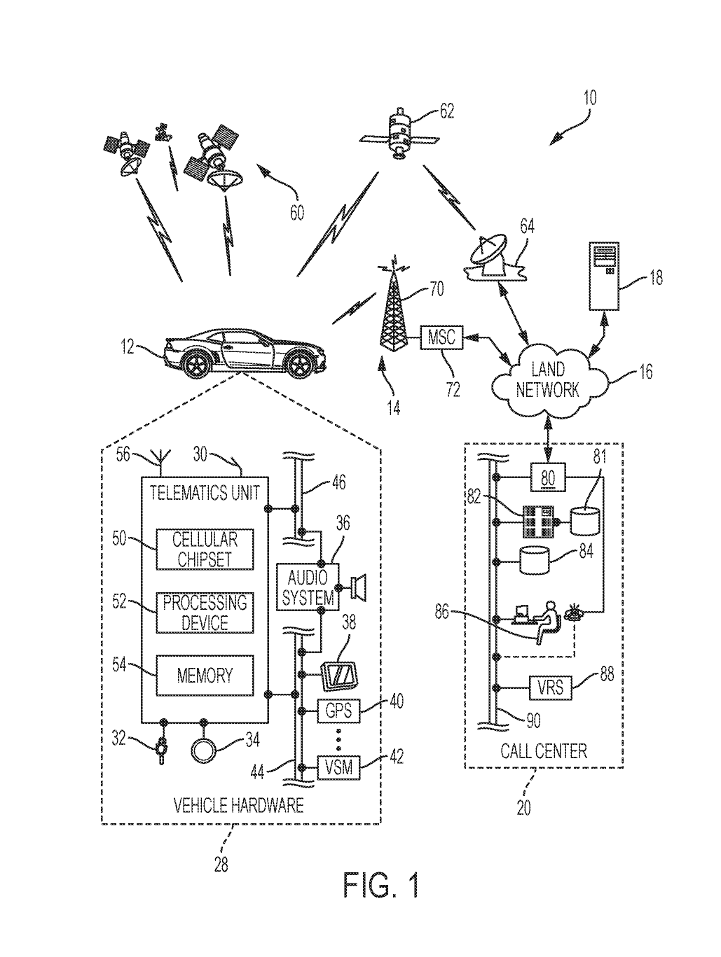

With reference to FIG. 1, there is shown an operating environment that includes, among other features, a mobile vehicle communications system 10 and that can be used to implement the method disclosed herein. Communications system 10 generally includes a vehicle 12, one or more wireless carrier systems 14, a land communications network 16, a computer 18, and a data center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that is installed in the vehicle and that enables wireless voice and/or data transmissions over wireless carrier system 14 and via wireless networking. This enables the vehicle to communicate with data center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the data center 20) and data communication (e.g., to provide GPS location data or vehicle diagnostic data to the data center 20), the system can utilize a single call over a voice channel and switch as needed between voice and data transmission over the voice channel, and this can be done using techniques known to those skilled in the art.

According to one embodiment, telematics unit 30 utilizes cellular communication according to various standards such as, but not limited to, the 3GPP (Third Generation Partnership Project) or 3GPP2 (Code Division Multiple Access) standards and thus includes a cellular chipset 50 for voice communications like hands-free calling, a wireless modem for data transmission, an electronic telematics controller device 52, one or more digital memory devices 54, and a dual antenna 56. It should be appreciated that the modem can either be implemented through software stored in the telematics unit 30 and is executed by controller 52, or it can be a separate hardware component located internal or external to telematics unit 30. The modem can operate using any number of different standards or protocols such as, but not limited to, GSM, EVDO, CDMA, GPRS, EDGE, UMTS and LTE. Wireless networking between the vehicle and other networked devices can also be carried out using telematics unit 30. For this purpose, telematics unit 30 can be configured to communicate wirelessly according to one or more wireless protocols, such as any of the IEEE 802.11 protocols, WiMAX, or Bluetooth. When used for packet-switched data communication such as TCP/IP, the telematics unit can be configured with a static IP address or can set up to automatically receive an assigned IP address from another device on the network such as a router or from a network address server.

Telematics controller 52 (processor) can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Telematics Controller 52 executes various types of digitally-stored instructions, such as software or firmware programs stored in memory 54, which enable the telematics unit to provide a wide variety of services such as, but not limited to, shifting between two or more connectivity modes to allow telematics unit 30 to activate antenna 56 so as to communicate with different types of an 3GPP cellular communication standard or different connectivity types of a single 3GPP standard. For instance, controller 52 can execute programs or process data to carry out at least a part of the method discussed herein.

Dual antenna 56 can include transmitter and receiver hardware components which allow for upload and download of data transmissions at various bandwidths and communication ranges. For instance, antenna 56 can transmit and receive Machine-Type Communications (MTC) wherein telematics unit 30 automatically communicates with a remotely located machine, such as, but not limited to, computer 18 or a server located at data center 20 (discussed below). When telematics unit 30 utilizes a mode of conducting cellular communications according to a 4G LTE, antenna 56 can transmit and receive Category 1 and higher communications. However, when telematics unit 30 utilizes a mode of conducting cellular communications according to a 4.5 and/or 5G GSM, antenna 56 can transmit and receive communications at one or more of the following Internet of Things connectivity types—Category 0 (Cat-0), Category M1 (Cat-M1), LTE MTC (LTE-M), Category NB1 (NB-IoT/Cat-NB1), Extended Coverage 3GPP for IoT (EC-GSM-IoT/EC-EGPRS), Lower Power Wide Area (LPWA), eDRX, and PSM. It should be appreciated that telematics unit 30 is not limited to a single communications standard (or connectivity type for each standard) and can be configured to utilize multiple cellular communication standards in accordance with 3GPP and/or 3GPP2 standards. It should be further appreciated that communications system 10 may include up to eight antennas or more.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to data center 20 or other remote computer system, such as computer 18, for other purposes, such as fleet management. Also, new or updated map data can be downloaded to the GPS module 40 from the data center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the data center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions (i.e., capable of GUI implementation). Various other vehicle user interfaces can also be utilized, as the interfaces of FIG. 1 are only an example of one particular implementation.

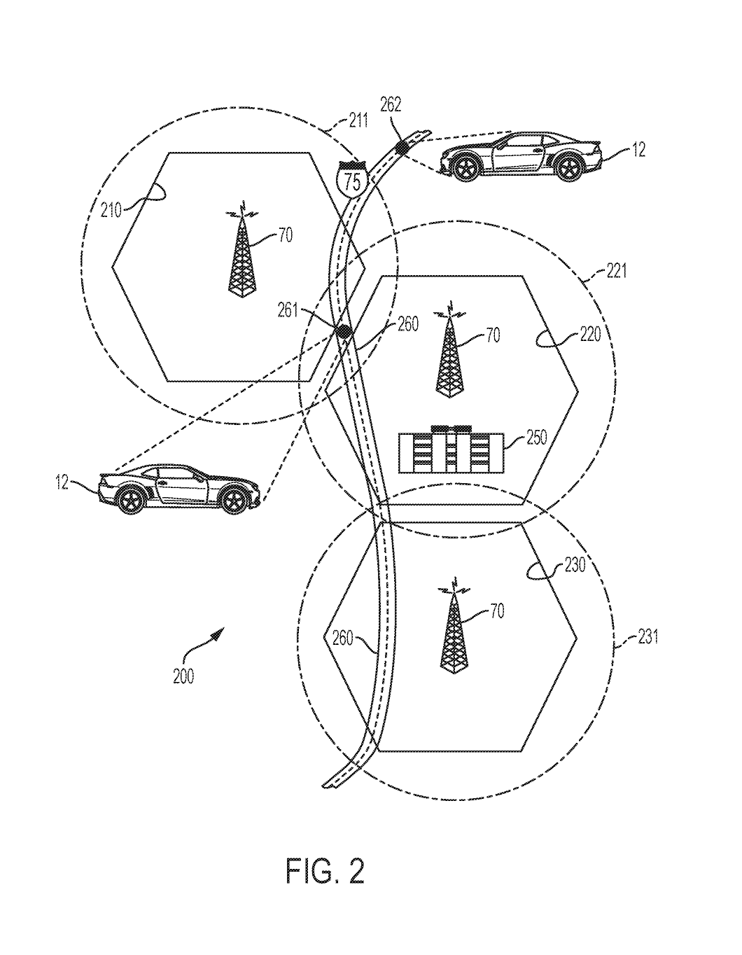

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000 or 1×EV-DO) or GSM/GPRS/UMTS/LTE (e.g., 3G, 4G LTE, 4.5G, and/or 5G). As will be appreciated by those skilled in the art, various cell tower 70/base station/MSC arrangements are possible and could be used with wireless system 14. For instance, the base station and cell tower 70 could be co-located at the same site or they could be remotely located from one another (as exemplified in FIG. 2), each base station could be responsible for a single cell tower or a single base station could service various cell towers 70, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to data center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, data center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or data center 20, or both. A computer 18 can also be used for providing Internet connectivity such as DNS services or as a network address server that uses DHCP or other suitable protocol to assign an IP address to the vehicle 12.

Data center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various data center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. Server 82 can incorporate a data controller 81 which essentially controls the overall operation and function of server 82. Controller 81 may control, send, and/or receive data information (e.g., data transmissions) from one or more of the data bases 84 and mobile computing device 57. Controller 81 is capable of reading executable instructions stored in a non-transitory machine readable medium and may include one or more from among a processor, a microprocessor, a central processing unit (CPU), a graphics processor, Application Specific Integrated Circuits (ASICs), Field-Programmable Gate Arrays (FPGAs), state machines, and a combination of hardware, software and firmware components. The live advisor phone can also use VoIP as indicated by the broken line in FIG. 1. VoIP and other data communication through the switch 80 is implemented via a modem (not shown) connected between the switch 80 and network 90.

Data transmissions are passed via the modem to server 82 and/or database 84. Database 84 can store account information such as, but not limited to, vehicle dynamics information and other pertinent subscriber information. Data transmissions may also be conducted by wireless systems, such as 802.11x, GPRS, and the like. Although the illustrated embodiment has been described as it would be used in conjunction with a manned data center 20 using live advisor 86, it will be appreciated that the data center can instead utilize VRS 88 as an automated advisor or, a combination of VRS 88 and the live advisor 86 can be used.

FIG. 2 illustrates an operating environment 200 that illustrates multiple cellular communication connectivity zones in which each zone type is of a certain bandwidth. The environment 200 has several cellular regions or cells or regions of normal operation 210, 220, 230 (cellular operations generally at more than one Mbps or those found in LTE UE categories 1 and above). An example of these cellular regions being one in which the telematics unit 30 may conduct cellular communications according to a single “one size fits all” connectivity type associated with 3GPP 2G. 3G and 4G standards or one or more connectivity types associated with the 4.5G and 5G GSMs. The telematics unit 30 may moreover operate at a connectivity mode (type) that allows for a prescribed or predetermined energy budget.

FIG. 2 also illustrates zones of extremely low-service connectivity 211, 221, and 231. Each low-connectivity zone 211, 221, and 231 extends outside the normal operation zones 210, 220, and 230 and may overlap the other low-connectivity zones to a certain extent. An example of these low-connectivity cellular regions being zones in which the telematics unit 30 is generally restricted to conduct cellular communications according to an Internet-of-Things connectivity type (e.g., NB LTE-M/LTE-M/EC-GSM/LPWA/eDRX/PSM) associated with the 4.5G and 5G GSMs. In essence, these zones do not have the cellular signal quality to adequately carry transmissions of a normal connectivity type.

The Internet-of-Things connectivity types generally require lower energy in the standby/sleep state (reduced energy consumption), and has broader, more robust, coverage with a link budget typically around 15-20 dB better than those other cellular communications being in accordance with 2G, 3G, and/or 4G LTE. The Internet-of-Things (IoT) connectivity type is also more pervasive than other connectivity types and can enter into and go through certain physical barriers such as, but not limited to, parking garage 250. In many instances, the Internet-of-Things connectivity may be implemented to connect smart machines (e.g., vending machines, copy machines, HVAC units, etc.) within physically encapsulated locations 250 to wireless carrier system 14. Skilled artisans will recognize normal connectivity types are those having data rates above that of the Internet-of-Things connectivity (i.e., normal connectivity types are typically more than one Mbps or those found in LTE UE categories 1 and above).

For example, while traveling at location 261, in between operation zones (e.g., between zones 210 and 220 while on road 260), a first type of connectivity-type event (trigger) may occur wherein data transmissions of the normal (i.e., first) connectivity type fail to reach wireless carrier system 14 (i.e., due to extremely poor wireless signal conditions). As such, controller 52 may be configured to recognize this connectivity-type event and in turn shift telematics unit 30 to a mode that implements the Internet-of-Things connectivity type to establish communications with wireless carrier system 14. In certain instances, while in the shifted mode incorporating the Internet-of-Things connectivity type, it may happen that vehicle 12 travels beyond the bounds of all wireless connectivity. In such instances, controller 52 may be further configured to shift telematics unit 30 back to its original mode state, which incorporates a normal connectivity type, in an effort to reestablish communications with wireless carrier system 14.

A similar second type of connectivity-type event may occur while vehicle 12 is at location 262. Due to there being no service connectivity at this location 262 (e.g., outside all connectivity zones while on road 260), all data transmissions fail to reach wireless carrier system 14. As such, controller 52 may be configured to recognize this connectivity-type event and in turn shift telematics unit 30 to a mode that implements the Internet-of-Things connectivity type, in an effort to have a better chance at establishing communications with wireless carrier system 14.

Whenever telematics unit 30 is in the shifted mode, which incorporates the Internet-of-Things connectivity type, controller 52 may be configured to periodically check the service connectivity strength around vehicle 12 (i.e., a type of retry process). As a result, whenever controller 52 realizes vehicle 12 is at a location of improved wireless carrier system service (e.g., returning back to being within the bounds of one of the normal operation zones 210, 220, 230) or otherwise has the ability to connect to wireless carrier system 14, controller 52 may shift telematics unit 30 back to reestablish the original mode state and implement a normal connectivity type.

A third type of connectivity-type event may moreover be incurred due to a failed attempt to send a vehicle-crash notification and/or establish an emergency (EMER) communication (e.g., attempted while in an area of poor/no wireless carrier system service). It should also be appreciated that the vehicle-crash notification may be an Advanced Automatic Collision Notification (AACN) that includes dispatch info (vehicle-crash severity and vehicle location) sent to data center 20 so as to allow live advisor 86 to subsequently contact nearby emergency/medical personnel. It should be further appreciated that an emergency communication may be established upon the commanding of one or more pushbuttons 34 to immediately, directly connect telematics unit 30 to live advisor 86 and cause advisor 86 to subsequently contact nearby emergency/medical personnel. Upon completion of the vehicle-crash notification and/or Emergency communication, controller 52 may be further configured to shift telematics unit 30 back to its original mode state, which incorporates a normal connectivity type.

In accordance with another aspect of the telematics unit management method, if the vehicle 12 were turned OFF (e.g., while parked in a parking lot 250) to create a fourth type of connectivity-type event, which may be considered an energy reduction event, controller 52 may detect the cutoff of battery energy and subsequently cause telematics unit 30 to operate according to a low-energy mode which enables telematics unit 30 to utilize an Internet-of-Things connectivity type. Operating in this low-energy mode allows telematics unit 30 draw less energy from the energy source (e.g., vehicle battery) of vehicle 12, to increase the energy budget of vehicle 12, and thus extend vehicle functionality time while being turned OFF, which may be up to hundreds of days longer than other connectivity types. A fifth type of connectivity-type event, which may also be considered an energy reduction event, would occur when the vehicle battery fails (e.g., the battery loses all charge). Controller 52 may detect a predetermined state-of-charge considered to be a battery energy failure and cause telematics unit 30 to operate according to a low-energy mode, which enables telematics unit 30 to utilize an Internet-of-Things connectivity type. Skilled artisans would see that telematics unit 30 may require an independent backup battery to remain functional throughout the duration of these connectivity-type events.

While vehicle 12 is operating on a predetermined state-of-charge that is the battery having a low energy level (e.g., below 25%), a sixth type of connectivity-type event, which may also be considered an energy reduction event, may be established and controller 52 may detect this predetermined state-of-charge and cause telematics unit 30 to operate according to the low-energy mode. This connectivity-type event may be beneficial in those instances when a vehicle-crash notification and/or emergency communication is being attempted, so that the vehicle battery does not fail at some point during communications. Skilled artisans would see that the predetermined state-of-charge may be some other charge state not discussed herein.

Whenever telematics unit 30 is in the shifted low-signal mode, controller 52 may be configured to periodically/continuously check the vehicle battery charge strength (i.e., a type of retry process). As a result, whenever controller 52 realizes vehicle battery strength has improved to a level in which the battery can continuously maintain a normal connectivity with wireless carrier system 14 (e.g., the vehicle is turned to an ON state, the vehicle battery state-of-charge improves, the vehicle battery has been restored, a new battery has been installed, etc.), controller 52 may shift telematics unit 30 back to reestablish the original mode state and implement a normal connectivity type.

It should be appreciated that controller 52 may also include one or more executable instructions that provide a timing function and which are configured to cause telematics unit 30 to operate according to this low-signal mode at a specific time, which may be commanded by the vehicle operator or data center 20. For example, based on the operations normal to vehicle 12, controller 52 may be set to shift modes at the specific time of lam (and could be further set to shift back to a normal connectivity type at 5 am). Telematics unit 30 may also shift to the low-signal mode at a specific time considered to be the expiration of a predetermined timer value (which may further be dependent upon the detection of a separate connectivity-type event). For example, controller 52 may be instructed to operate according to the low-energy mode after vehicle 12 has been turned OFF for the specific time of 30 minutes.

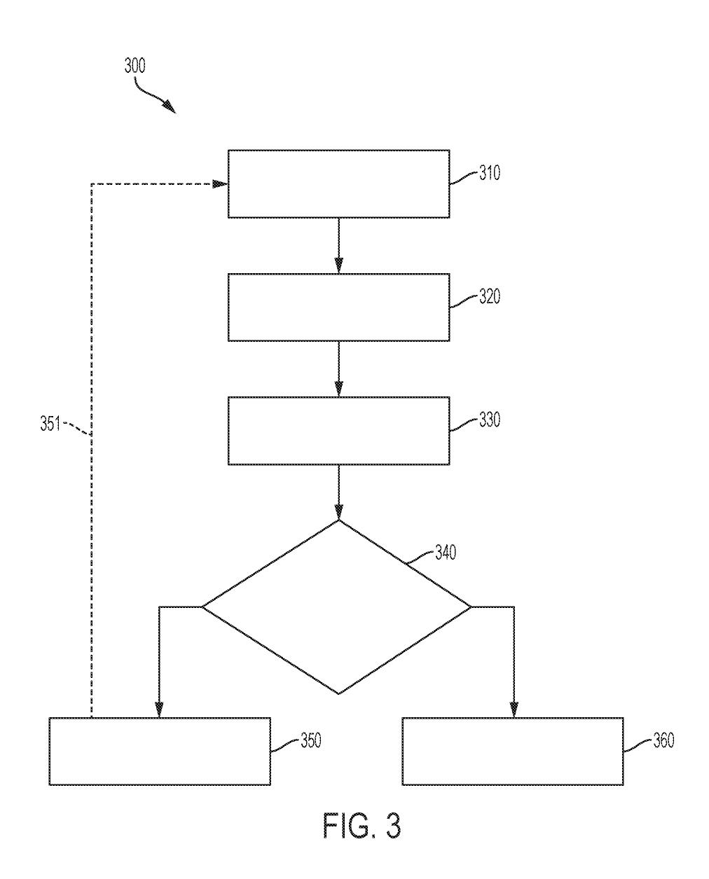

Turning now to FIG. 3, there is shown an example of method 300 of telematics unit connectivity management. One or more steps of method 300 may be completed through the implementation of controller 52 which may include one or more executable instructions incorporated into memory 54 and executed by of telematics unit 30 and antenna 56. One or more aspects of method 300 may moreover be implemented by server 82 of data center 20 which may include one or more executable instructions incorporated into data base 81 and executed by of telematics unit 30 and antenna 56 (which may be conducted via one or more satellites 62).

The method is supported by telematics unit 30 being configured for connectivity management having a two or more connectivity modes. This configuration may be made by a vehicle manufacturer at or near the time of the telematics unit's assembly or after-market (e.g., via vehicle download using the afore-described communication system 10 or at a time of vehicle service, just to name a couple of examples). In at least one implementation, one or more instructions are provided to the telematics unit and stored on non-transitory computer-readable medium (e.g., on memory 54).

Step 310 includes preconfiguring telematics unit 30 by setting the unit at a first connectivity mode. As discussed above, this first connectivity mode may include enabling telematics unit 30 to transmit data at one or more normal connectivity type.

Step 320 includes telematics unit 30 establishing data transmissions connectivity with wireless carrier system 14 while in the first connectivity mode. Such transmissions may be implemented through one or more antennas 56. This step may further include controller 52 being configured to analyze these transmissions so as to determine their data rate and any variances thereof, as well as the durations of signal strength less than the threshold and greater than the threshold. And other factors may be accounted for as well.

Step 330 includes vehicle 12 traveling beyond the bounds of the regions of normal cellular operation 210, 220, 230 while still being covered by one or more low-connectivity zones 211, 221, and 231. At step 330, vehicle 12 may encounter a situation in conformity with the first, second, and/or third type of connectivity-type event. For example, the operator may be required to attempt to send a vehicle-crash notification and/or emergency communication. However, due to the vehicle 12 being outside of normal cellular operations, the attempted vehicle-crash notification and/or emergency communication fails because the low-connectivity zone, in which vehicle 12 remains, cannot carry the minimum data rate required for these communications. In another example, the operator may to attempt to send a data transmission through a normal connectivity type. However, due to the vehicle 12 being outside of normal cellular operations (e.g. being located in one or more low-connectivity zones 211, 221, and 231) or in an area of no cellular operations, the attempted data transmissions fail.

At step 340, telematics unit 30 will have to determine that vehicle 12 has encountered a connectivity-type event. To make such a determination, telematics unit 30 may attempt to reestablish communications with wireless carrier system 14 through a retry process. Such a retry process may include telematics unit 30 making one or more additional vehicle-crash notifications and/or emergency communications to ensure that vehicle 12 is actually encountering a connectivity-type event or if the call failed for some other technical reason. The retry process may also include telematics unit 30 attempting to communicate with wireless carrier system 12 through the various means as discussed above. Telematics unit 30 may also, for example, determine the strength of a wireless or cellular signal and/or determine that the signal strength intermittently varies less than and/or greater than a predefined threshold value. It may further include determining the data rate of these variances, as well as the durations of signal strength less than the threshold and greater than the threshold. Other factors may be accounted for as well.

If for one reason or another, the retry process is successful in reestablishing communications with wireless carrier system 14 method 300 will move to step 360 and conclude method 300 by completing the vehicle-crash notification and/or emergency communication. However, if telematics unit 30 adequately determines vehicle 12 has encountered a connectivity-type event, then method 300 will move to step 350. At step 350, telematics unit 30 will shift from the established first connectivity mode (i.e., at a normal connectivity type data rate) to a second connectivity mode at an Internet-of-Things connectivity type. As stated above, such a connectivity type may be established in accordance with a 4.5G and/or 5G 3GPP standard. While in the established Internet-of-Things connectivity type, telematics unit 30 will establish data transmissions connectivity with wireless carrier system 14. Establishing transmissions in this connectivity type should have a higher chance of success, as discussed above. Once transmissions are established, telematics unit 30 will then resend the previously failed vehicle-crash notification and/or emergency communication. It should be appreciated, due to the Internet-of-Things connectivity type specifications, telematics unit 30 may send the call in a text format having the necessary information of the call.

As demonstrated by optional line 351, method 300 may exit the Internet-of-Things connectivity type, for example, when vehicle 12 reenters normal cellular operation regions 210, 220, 230. If the vehicle 12 is back within a region of normal cellular operation, the method may proceed to step 310 again. Thereafter, the method may repeat its steps.

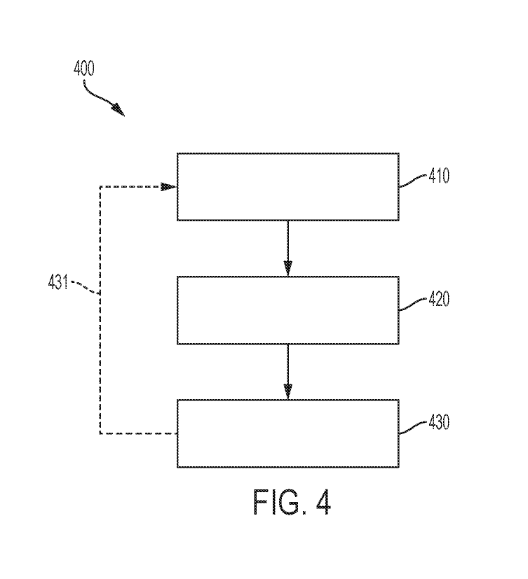

Turning now to FIG. 4, there is shown an example of method 400 of telematics unit connectivity management. One or more steps of method 400 may be completed through the implementation of controller 52 which may include one or more executable instructions (software algorithms) incorporated into memory 54 and executed by of telematics unit 30 and antenna 56. One or more aspects of method 400 may moreover be implemented by server 82 of data center 20 which may include one or more executable instructions (software algorithms) incorporated into data base 81 and executed by of telematics unit 30 and antenna 56 (which may be conducted via one or more satellites 62).

The method is supported by telematics unit 30 being configured for connectivity management having a two or more connectivity modes. Similar to the method discussed above, this configuration may be made by a vehicle manufacturer at or near the time of the telematics unit's 30 assembly or after-market (e.g., via vehicle download using the afore-described communication system 10 or at a time of vehicle service, just to name a couple of examples). In at least one implementation, one or more instructions are provided to the telematics unit 30 and stored on non-transitory computer-readable medium (e.g., on memory 54).

Step 410 includes preconfiguring telematics unit 30 by setting the unit at a first connectivity mode. As discussed above, this first connectivity mode may include enabling telematics unit 30 to transmit data at one or more normal connectivity types.

Step 420 includes telematics unit 30 encountering the connectivity-type event in conformity with the fourth, fifth, and/or sixth type of connectivity-type event. For example, vehicle 12 being turned OFF. Telematics unit 30 may therefore be required to determine that the circumstances are such that the vehicle engine is OFF and the vehicle battery is not being charged (e.g., an electric vehicle being both OFF and isolated from a charging station). One of the VSMs 42, such as ECM, may provide an indication of the OFF state to the telematics unit 30. In another example, the vehicle is operating on a battery at a predetermined state-of-charge (e.g., the battery having a low energy level, no charge, or failure).

When telematics unit 30 adequately determines vehicle 12 has encountered a connectivity-type event, method 400 moves to step 430. At step 430 telematics unit 30 will shift from the established first connectivity mode (i.e., at a normal connectivity type) to the Internet-of-Things connectivity type (i.e., second connectivity mode). In method 400, this connectivity mode may be considered an energy-saving mode and method 400 may be considered an energy management method for a telematics unit. The energy-saving mode may enable telematics unit 30 to be operative and perform its desired functions (e.g., remote start, remote door unlock, supporting powertrain operation, etc.) for an elongated time duration (e.g., greater than 100 days), or for a predetermined time period, and ensures that the telematics unit 30 does not fully discharge or excessively drain the vehicle battery's energy while the vehicle is OFF. As demonstrated by line 431, Method 400 may exit the energy-saving mode, for example, when the vehicle may be powered ON (e.g., vehicle ignition started, an electric vehicle may be plugged into an energy source, etc.). If the vehicle 12 is turned ON, the vehicle battery charge rejuvenates, or the battery becomes operational again, the method may proceed to step 410 again. Thereafter, the method 400 may repeat its steps from the beginning of step 410.

In certain instances, as discussed above, telematics unit 30 and/or controller 52 may be configured to incorporate timing/clock program that allows the operator to set a specific time for telematics unit 30 to shift from the established first connectivity mode (i.e., at a normal connectivity type) to a second connectivity mode at the Internet-of-Things connectivity type. This program may moreover first be required to determine the vehicle engine is OFF before shifting to the Internet-of-Things connectivity type. For example, when an operator knows their schedule is such that they do not typically operate vehicle 12 between the hours of 12 am (midnight) to 5 am, they may set the timing/clock program to shift telematics unit 30 to the Internet-of-Things connectivity type mode during these hours. Telematics unit 30 may further be configured to shift to the Internet-of-Things connectivity type mode when the vehicle has been OFF for a predetermined time (e.g., 30 minutes). If vehicle 12 is ON or has not been OFF for less than the predetermined time, however, telematics unit 30 will refrain from such a mode shift (at least until being OFF for more than the predetermined time). It should be appreciated that the methods described herein may be used in implementations other than a vehicle.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method of connectivity management of a telematics unit, the method comprising:
(a) setting, via a controller, a telematics unit at a first connectivity mode;
(b) establishing, via an antenna, communications with a wireless carrier system at the first connectivity mode;
(c) determining, via the controller, that the vehicle has encountered a connectivity-type event;
(d) shifting, via the controller, the telematics unit from the first connectivity mode to a second connectivity mode; and
(e) establishing, via the antenna, communications with the wireless carrier system at the second connectivity mode.

2. The method of claim 1, further comprising attempting to reestablish, via the controller, the wireless carrier system communications at the first connectivity mode.

3. The method of claim 1, wherein the connectivity-type event is the vehicle being OFF.

4. The method of claim 1, wherein the connectivity-type event is the vehicle operating on a battery having a predetermined state-of-charge.

5. The method of claim 1, wherein the connectivity-type event is created by the controller based on a specific time.

6. The method of claim 5, wherein the specific time is based upon the expiration of a predetermined timer value.

7. The method of claim 1, wherein the connectivity-type event is a failed attempt to send a vehicle-crash notification and/or establish an emergency communication.

8. The method of claim 1, wherein the connectivity-type event occurs when normal connectivity types fail to reach wireless carrier system or the vehicle is at a location with no service connectivity.

9. The method of claim 1, wherein the second connectivity mode allows data transmissions to occur at an Internet-of-Things connectivity type.

10. A method of connectivity management of a telematics unit in a vehicle, the method comprising:
(f) setting, via a controller, a telematics unit transmits data at a normal connectivity type;
(g) establishing, via an antenna of the telematics unit, communications with a wireless carrier system at the normal connectivity type;
(h) determining, via the controller, that the telematics unit has failed an attempt to send a vehicle-crash notification and/or establish an emergency communication, and/or the normal connectivity type communications fail to reach wireless carrier system, and/or the vehicle is at a location with no service connectivity;
(i) shifting, via the controller, the telematics unit from the normal connectivity type to an Internet-of-Things connectivity type; and
(j) establishing, via an antenna of the telematics unit, communications with the wireless carrier system at the Internet-of-Things connectivity type.

11. The method of claim 10, further comprising attempting to reestablish the wireless carrier system communications, via the controller, at the first connectivity mode.

12. The method of claim 10, wherein the data transmissions are in accordance with a 4.5G and/or 5G 3GPP standard.

13. A non-transitory machine readable medium having stored thereon executable instructions to manage a telematics unit, comprising machine executable code which when provided a telematics unit of a vehicle and executed by at least one machine, causes the telematics unit to:
(a) set the telematics unit to a first connectivity mode;
(b) establish communications with a wireless carrier system at the first connectivity mode and through an antenna;
(c) determine that the vehicle has encountered a connectivity-type event;
(d) shift the telematics unit from the first connectivity mode to a second connectivity mode; and
(e) establish communications with the wireless carrier system at the second connectivity mode.

14. The non-transitory machine readable medium of claim 13, further comprising attempting to reestablish the wireless carrier system communications, via the controller, at the first connectivity mode.

15. The non-transitory machine readable medium of claim 13, wherein the connectivity-type event is the vehicle being OFF.

16. The non-transitory machine readable medium of claim 13, wherein the connectivity-type event is the vehicle operating on battery having a predetermined state-of-charge.

17. The non-transitory machine readable medium of claim 13, wherein the connectivity-type event is a failed attempt to send a vehicle-crash notification and/or establish an emergency communication.

18. The non-transitory machine readable medium of claim 13, wherein the connectivity-type event occurs when normal connectivity types fail to reach wireless carrier system or the vehicle is at a location with no service connectivity.

19. The non-transitory machine readable medium of claim 13, wherein the first connectivity mode allows data transmissions to occur at one or more normal connectivity types.

20. The non-transitory machine readable medium of claim 13, wherein the second connectivity mode allows data transmissions to occur at an Internet-of-Things connectivity type.
